(19) United States
(12) Patent Application Publication
(10) Pub. No.: US 2023/0264241 A1
(43) Pub. Date: Aug. 24, 2023

(54) A BEVERAGE CAPSULE RECYCLING ASSEMBLY

(71) Applicant: My eSolution Pty Ltd, Bulimba, Brisbane, Queensland (AU)

(72) Inventor: Mandy Blyss, Queensland (AU)

(21) Appl. No.: 18/010,079

(22) PCT Filed: Jun. 18, 2021
(86) PCT No.: PCT/AU2021/050639

§ 371 Date: Dec. 13, 2022

(30) Foreign Application Priority Data
Jun. 24, 2020 (AU) 2020902111

(51) Int. Cl. B09B 3/35

(52) U.S. Cl. CPC B09B 3/35; B09B 2101/70

(57) ABSTRACT

A beverage capsule recycling assembly for preparing a beverage capsule for recycling, the beverage capsule recycling assembly having a body portion, a cutter portion integral with or attachable to the body portion, the cutter portion having a blade member to cut a lid of the beverage capsule, a first crush portion associated with the body portion, and a second crush portion, wherein when the first crush portion and the second crush portion are in a use condition, the beverage capsule can be located between the first crush portion and the second crush portion, and the first crush portion can be moved towards the second crush portion to compact the beverage capsule.

### FIELD OF INVENTION

The present invention relates to a beverage capsule recycling assembly. The present invention has particular but not exclusive application for preparing single use aluminium coffee capsules for recycling. The patent specification describes this use but it is by way of example only and the invention is not limited to this use.

### BACKGROUND OF THE INVENTION

Single use beverage capsules such as coffee capsules simplify the process of preparing beverages. Coffee capsules eliminate the need for a user to grind coffee beans, measure out a correct portion and tamp the ground beans. The coffee capsules are desirable as they can provide a consistent strength and flavour of the brewed beverage, which can be difficult to achieve with manual type coffee, espresso and cappuccino machines. The individually packaged nature of single use capsules assist in keeping the product fresh by avoiding exposure of a large batch of ground coffee to air and light.

A major problem with the single use capsules is that the capsules significantly add to the global waste production.

Another problem with single use capsules is that they are difficult to recycle due to the organic material contained in the capsules. An estimated 20 billion single use coffee capsules are used every year globally, with approximately 75% entering landfill, where they can take up to 500 years to break down.

One prior art solution is to use biodegradable material for the capsules. While this is an acceptable solution, the biodegradable capsules are typically packed in plastic film to help keep the contents fresh, the plastic film itself can become a waste problem. The majority of ‘biodegradable’ capsules require industrial composting facilities that shred the capsules and biodegrade them in temperature-controlled compost heaps.

Aluminium capsules can be recycled if the organic material is removed from the capsule. However, the capsules are typically too small to be effectively sorted in recycling plants and ultimately end up in landfills.

There are dedicated recycling schemes to recycle aluminium capsules. However, these recycling schemes are expensive and typically require a consumer to stockpile used coffee capsules until a significant amount can be sent to or picked up by a recycling scheme. These are known as “collect & return” recycling schemes.

A problem with current “collect & return” recycling schemes is that these result in further emissions from transporting and processing aluminium capsules at a dedicated facility.

### OBJECT OF THE INVENTION

It is an object of the present invention to overcome or at least alleviate one or more of the above mentioned problems with single use beverage capsules and/or provide the consumer with a useful or commercial choice.

### SUMMARY OF THE INVENTION

In one aspect, the present invention broadly resides in a beverage capsule recycling assembly for preparing a beverage capsule for recycling, the beverage capsule recycling assembly having

a body portion

a cutter portion integral with or attachable to the body portion, the cutter portion having a blade member to cut a lid of the beverage capsule;

a first crush portion associated with the body portion; and

a second crush portion,

wherein when the first crush portion and the second crush portion are in a use condition, the beverage capsule can be located between the first crush portion and the second crush portion, and the first crush portion can be moved towards the second crush portion to compact the beverage capsule.

Preferably, one of the first crush portion or the second crush portion includes a score member. Preferably when the beverage capsule is being compacted between the first crush portion and the second crush portion, the score member scores an indentation into the beverage capsule. Preferably the indentation assists a user to fold the compacted beverage capsule. Preferably the second crush portion has the score member. In one embodiment the first crush portion has the score member. In another embodiment, both the first crush portion and the second crush portion have a score member. In another embodiment, one of the first crush portion or the second crush portion includes a plurality of score members. Preferably the plurality of score members is two score members. Preferably the two score members are angled to each other. Preferably the two score members intersect each other. Preferably the two score members define a cross.

Preferably the first crush portion is made of a plastic material. Alternatively, the first crush portion is made of a metallic material. In one embodiment, the first crush portion is made of aluminium.

Preferably the second crush portion is made of a plastic material. Alternatively, the second crush portion is made of a metallic material. In one embodiment, the second crush portion is made of aluminium.

Preferably the first crush portion is substantially circular in cross section.

Preferably the second crush portion is substantially circular in cross section.

Preferably the score member is in the form of a ridge. Preferably the score member extends along a planar surface of the first crush portion and/or the second crush portion.

Preferably one of the first crush portion or second crush portion includes a collar portion. Preferably the collar portion assists in locating the beverage capsule prior to the beverage portion being compacted. Preferably the collar portion is at least as high as the height of a beverage capsule. Preferably the collar portion is adapted to align the first crush portion and the second crush portion. Preferably one of the first crush portion or second crush portion includes one or more guides. Preferably the collar portion includes one or more guides. Preferably the one or more guides guide the first crush portion or second crush portion as it moves relative to the collar. Preferably the one or more guides enable air to escape between the collar portion and the first crush portion or second crush portion as it moves relative to the collar. Preferably the second crush portion includes the collar portion.

Preferably the first crush portion is attachable to the second crush portion. Preferably in a storage condition, the first crush portion is attached to the second crush portion.

Preferably the blade member is attached to or integral with the cutter portion. Preferably the blade member is arcuate. Preferably pushing the lid of the beverage capsule onto the blade member and rotating or twisting the beverage capsule relative to the cutter portion cuts the lid open. Preferably the lid is cut open with an arcuate cut. Preferably with the lid cut open, contents of the beverage capsule can be removed. Preferably the blade member is made of metal. In one embodiment, the blade member is made of steel. Preferably the steel is stainless steel. In another embodiment the blade member is made of aluminium. In another embodiment, the blade member is made of a plastic material. Preferably the blade member is semi circular in shape. In one embodiment, the blade member is substantially circular in shape. In another embodiment, there are a plurality of blade members attached to or integral with the cutter portion.

Preferably the cutter portion includes a shoulder portion to assist in guiding the beverage capsule as it is being rotated. Preferably the cutter portion includes an outer wall, preferably the outer wall extends further from a base portion of the cutter portion than the blade member. Preferably the cutter portion is made of a plastic material. Alternatively, the cutter portion is made of a metallic material. In one embodiment, the cutter portion is made of aluminium.

Preferably the cutter portion is substantially circular in cross section. Preferably the cutter portion is replaceable. Preferably the cutter portion can be replaced with a new cutter portion. In one embodiment, the cutter portion can be replaced with a cutter portion having a different sized blade member.

Preferably the cutter portion includes markings to indicate how much the beverage capsule needs to be rotated to cut the lid open and retain the lid to the capsule. Preferably the markings can be felt by a user's thumb or fingers. Preferably the markings are located on an outer part of the cutter portion.

Preferably the beverage capsule recycling assembly includes a spatula member. Preferably the spatula member is removably locatable within at least a portion of the body member. Preferably the spatula member is securable relative to the body member. Preferably the spatula member has a tongue portion which can be used to remove the contents of the beverage capsule when the lid has been cut open. Preferably the tongue portion is substantially planar. In another embodiment, the tongue portion is curved.

Preferably the spatula member is made of a plastic material. Alternatively, the spatula member is made of a metallic material. In one embodiment, the spatula member is made of aluminium.

Preferably the spatula member is attachable, attached or integral with the first crush portion. In another embodiment, the spatula member is attachable, attached or integral with the second crush portion.

In one embodiment, the spatula member is part of the body portion. Preferably in this embodiment, removing a cover exposes the spatula member. In one embodiment, the cover includes the first crush portion.

In another embodiment, the beverage capsule recycling assembly includes a cover portion to at least partially cover the spatula member in a storage condition. Preferably the cover portion is insertable into the body portion. In another embodiment, the cover portion is integral with the body portion.

Preferably the cover portion is substantially circular in cross section.

Preferably the beverage capsule recycling assembly includes a lid. Preferably the lid is attachable to the cutter portion. Preferably when the lid is attached to the cutter portion, the blade member is covered by the lid. Preferably the lid is substantially circular in cross section.

Preferably the body portion is substantially circular in cross section. Preferably the body portion has a first end and a second end. Preferably a middle section of the body portion has a smaller width than the first end and the second end. Preferably the body portion is made of a plastic material. Alternatively, the body portion is made of a metallic material. In one embodiment, the body portion is made of aluminium.

In one embodiment, the parts of the beverage capsule recycling assembly are predominantly made of a wooden material. In another embodiment, the parts of the beverage capsule recycling assembly are predominantly made of a ceramic material, a composite material, a plastic material and or a metallic material.

Preferably the beverage capsule is a coffee capsule. It will be understood that a coffee capsule may also be referred to as a coffee pod. Preferably the contents of the beverage capsule are coffee grounds. Preferably the beverage capsule is predominantly made of aluminium. More preferably the beverage capsule is made of aluminium. Preferably the lid of the beverage capsule is made of aluminium. In another embodiment, the beverage capsule is made of a plastic material.

In another aspect, the present invention broadly resides in a beverage capsule recycling assembly for preparing a beverage capsule for recycling, the beverage capsule recycling assembly having

a body portion;

a cutter portion integral with or attachable to the body portion, the cutter portion having a blade member to cut a lid of the beverage capsule;

a first crush portion associated with the body portion;

a second crush portion; and

a score member associated with one of the first crush member or the second crush member,

wherein when the first crush portion and the second crush portion are in a use condition, the beverage capsule can be located between the first crush portion and the second crush portion, and the first crush portion can be moved towards the second crush portion to compact the beverage capsule, and wherein when the beverage capsule is being compacted between the first crush portion and the second crush portion, the score member scores an indentation into the beverage capsule.

In a further aspect, the present invention broadly resides in a method of preparing a beverage capsule for recycling using a beverage capsule recycling assembly as described in this specification, including the steps of

locating the beverage capsule on the cutter portion such that the blade member cuts into a lid of the beverage capsule;

rotating the beverage capsule relative to the cutter portion such that the blade member cuts an opening into the lid of the beverage;

removing the contents of the beverage capsule;

locating the beverage capsule between the first crush portion and the second crush portion; and

moving the first crush portion towards the second crush portion to compact the beverage capsule.

Preferably the step of moving the first crush portion towards the second crush portion to compact the beverage capsule includes indenting the beverage capsule with a score member.

Preferably the method further includes the step of folding the compacted beverage capsule along the indentation.

Preferably the step of removing the contents of the beverage capsule includes using a spatula member to scoop the contents out of the beverage capsule.

Preferably the method further includes the step of inserting the compacted and folded beverage capsule into an aluminium can. Preferably the aluminium can is an aluminium drink can. In one embodiment, the aluminium can is a soft drink can or an alcoholic beverage can such as a beer can. Preferably the aluminium can is a used or empty can.

In another aspect, the present invention broadly resides in a beverage capsule recycling assembly for preparing a beverage capsule for recycling, the beverage capsule recycling assembly having

a body portion;

a cutter portion integral with or attachable to the body portion, the cutter portion having a blade member to cut a lid of the beverage capsule;

a first crush portion associated with the body portion; and

a score member,

wherein when the first crush portion is in a use condition, the beverage capsule can be compacted by the first crush portion and wherein the score member scores an indentation into the beverage capsule.

It will be understood that the term a beverage capsule recycling assembly refers to an assembly which prepares a beverage capsule for recycling.

Preferably the beverage capsule recycling assembly is a coffee pod recycling assembly.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is an exploded view of a beverage capsule recycling assembly according to an embodiment of the present invention;

FIG. 2 is a top perspective view of the beverage capsule recycling assembly of FIG. 1;

FIG. 3 is a bottom perspective view of the beverage capsule recycling assembly of FIG. 1;

FIG. 4 is a side view of the beverage capsule recycling assembly of FIG. 1;

FIG. 5 is a section view of the beverage capsule recycling assembly of FIG. 1;

FIG. 6 is a section view of the beverage capsule recycling assembly of FIG. 1;

FIG. 7 is a perspective view of a part of the body portion of FIG. 1;

FIG. 8 is a front view of the body portion part of FIG. 7;

FIG. 8A is a side view of the body portion part of FIG. 7;

FIG. 8B is a section view of the body portion part of FIG. 7;

FIG. 9 is a front view of a part of the body portion of FIG. 1;

FIG. 9A is a side view of a part of the body portion of FIG. 1;

FIG. 9B is a section view of a part of the body portion FIG. 1;

FIG. 10 is a perspective view of the body portion part of FIG. 9;

FIG. 11 is a perspective view of the beverage capsule recycling assembly of FIG. 1 with the lid removed;

FIG. 12 is a detailed view of FIG. 11;

FIG. 13 is a perspective view of the cutter portion of FIG. 1;

FIG. 14 is a lower perspective view of the cutter portion of FIG. 1;

FIG. 15 is a top view of the cutter portion of FIG. 1;

FIG. 15A is a section view of the cutter portion of FIG. 15;

FIG. 15B is a section view of the cutter portion of FIG. 15;

FIG. 16 is a top view of the first crush portion of FIG. 1;

FIG. 16A is a section view of the first crush portion of FIG. 16;

FIG. 17 is a perspective view of the second crush portion of FIG. 1;

FIG. 18 is a lower perspective view of the second crush portion of FIG. 1;

FIG. 19 is a top view of the second crush portion of FIG. 1;

FIG. 19A is a section view of the second crush portion of FIG. 19;

FIG. 19B is a bottom view of the second crush member of FIG. 19;

FIG. 20 is a perspective view of the spatula member of FIG. 1;

FIG. 21 is a perspective view of the spatula member of FIG. 1;

FIG. 22 is a top view of the spatula member of FIG. 1;

FIG. 22A is a side view of the spatula member of FIG. 1;

FIG. 22B is a front view of the spatula member of FIG. 1;

FIG. 23 is a perspective view of the cover portion of FIG. 1;

FIG. 24 is a lower perspective view of the cover portion of FIG. 1;

FIG. 25 is a top view of the cover portion of FIG. 1;

FIG. 25A is a section view of the cover portion of FIG. 25;

FIG. 25B is a side view of the cover portion of FIG. 25;

FIG. 26 is a perspective view of the lid of FIG. 1;

FIG. 27 is a lower perspective view of the lid of FIG. 1;

FIG. 28 is a top view of the lid of FIG. 1;

FIG. 28A is a section view of the lid of FIG. 28;

FIG. 29 is a side view of a beverage capsule recycling assembly according to another embodiment of the present invention;

FIG. 30 is a sectioned view of the beverage capsule recycling assembly of FIG. 29;

FIG. 31 is a sectioned view of the beverage capsule recycling assembly of FIG. 29;

FIG. 32 is a perspective view of the cutter portion of the beverage capsule recycling assembly of FIG. 29;

FIG. 33 is a perspective view of the first crush portion of the beverage capsule recycling assembly of FIG. 29;

FIG. 34 is a perspective view of the second crush portion of the beverage capsule recycling assembly of FIG. 29; and

FIG. 35 is a perspective view of the spatula member of the beverage capsule recycling assembly of FIG. 29.

### DETAILED DESCRIPTION OF THE PREFERRED EMBODIMENT

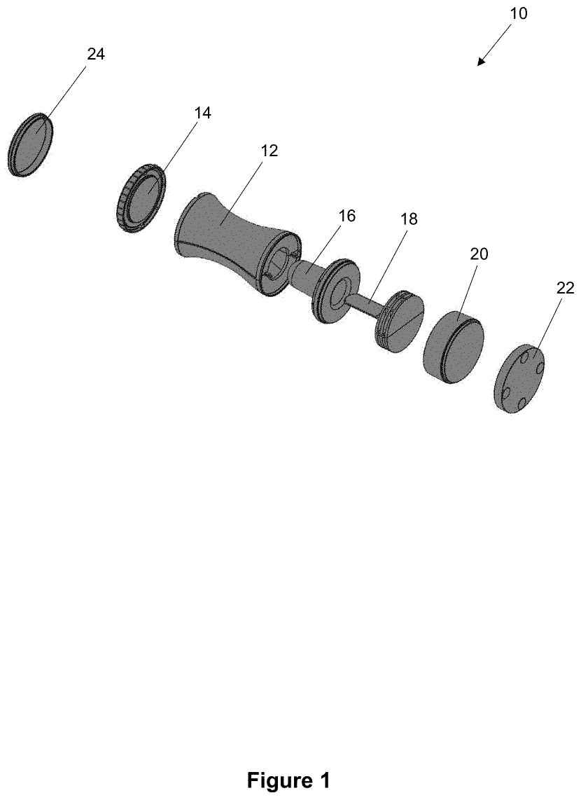

With reference to FIG. 1 there is shown a beverage capsule recycling assembly in the form of a coffee capsule recycling assembly 10 for preparing a coffee capsule (not shown) for recycling. The coffee capsule recycling assembly 10 has a body portion 12. A cutter portion 14 is attachable to the body portion 12.

The coffee capsule recycling assembly 10 has a cover portion 16 which partially fits into the body portion 12. The coffee capsule recycling assembly 10 includes a spatula member 18 which is insertable into the cover portion 16. A first crush portion 20 is attachable to the cover portion 16. The spatula member 18 is containable within a space defined by the cover portion 16 and the first crush portion when the cover member 16 and the first crush portion 20 are attached to each other.

The coffee capsule recycling assembly 10 includes a second crush portion 22. The second crush portion 22 is attachable to the first crush portion 20.

The coffee capsule recycling assembly 10 includes a lid 24 to cover the cutter portion 14.

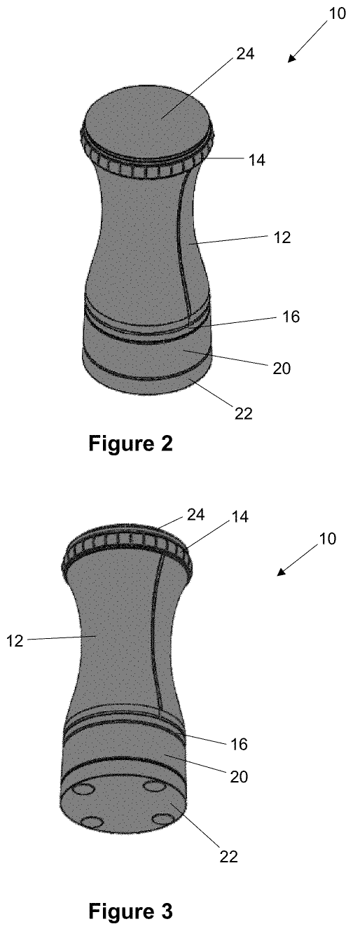

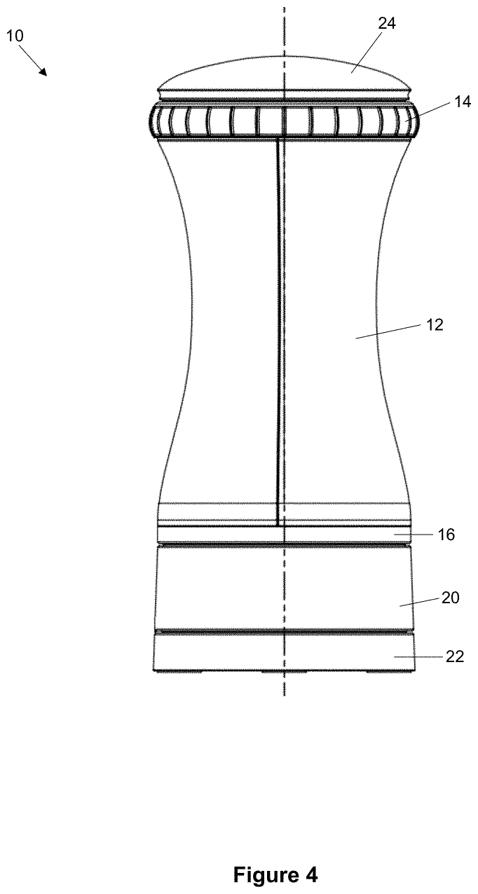

With reference to FIGS. 2-4 there is shown the coffee capsule recycling assembly 10 in a storage condition. The lid 24 is shown attached to the cutter portion 14. The cutter portion 14 is attached to the body portion 12. The cover portion 16 is attached to the body portion 12. The first crush member 20 is attached to the cover portion 16 and the second crush member 22 is attached to the first crush member 20.

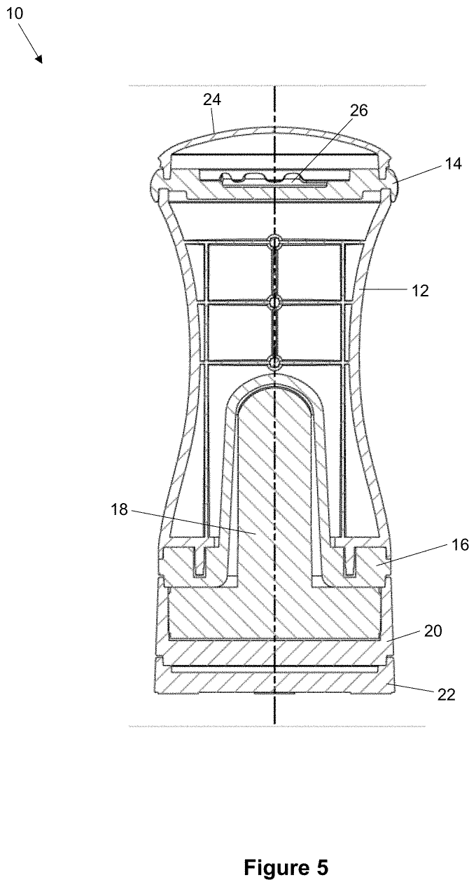

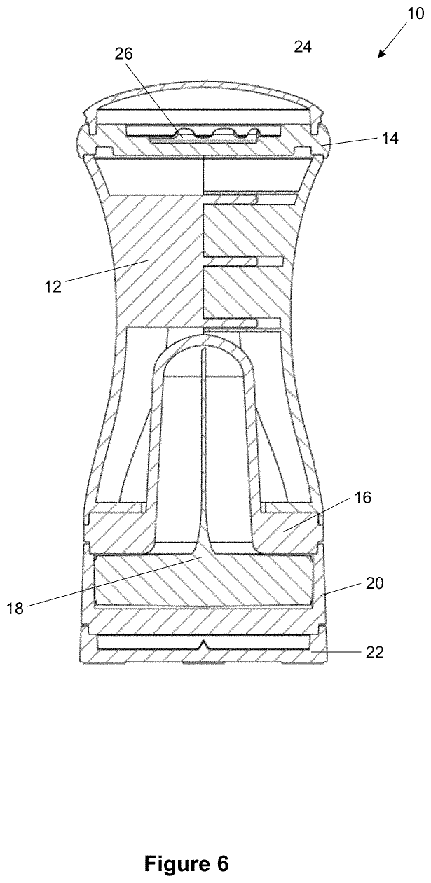

With reference to FIGS. 5 and 6, there are shown section views of the coffee capsule recycling assembly 10 in a storage condition. The figures show a blade member 26 attached to the cutter section 14. The blade member 26 is adapted to cut a lid of a coffee capsule (not shown) so that the coffee grounds in the coffee capsule are accessible. The Figures also show how the spatula member 18 is contained within a space defined by the cover member 16 and the first crush portion 20.

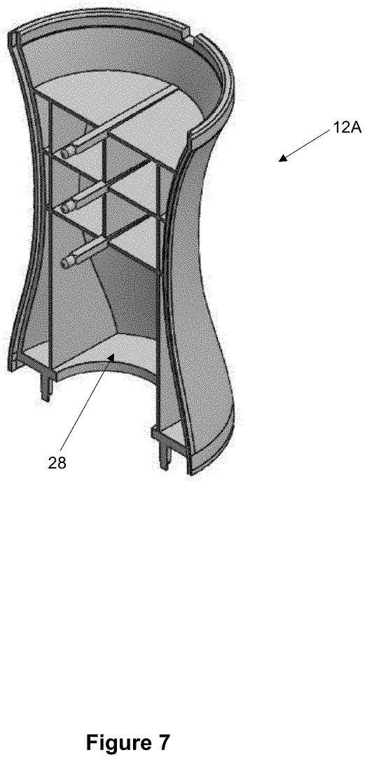

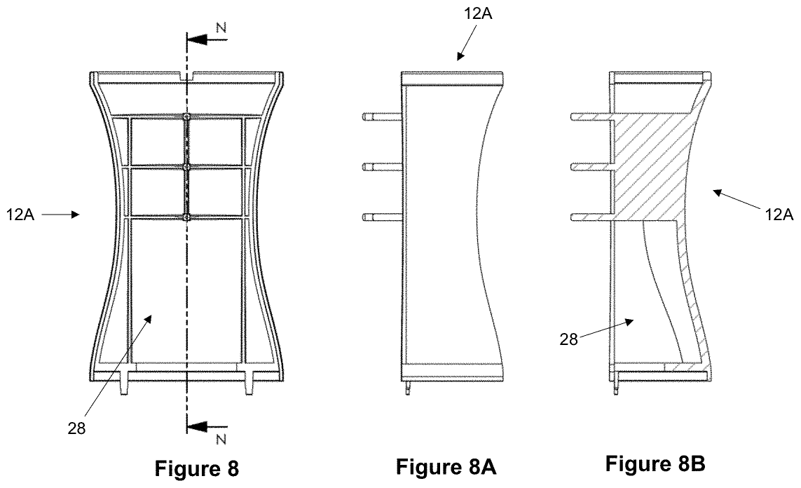

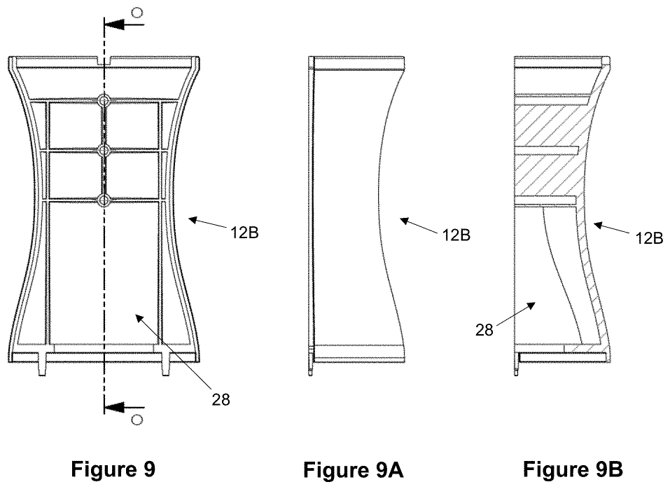

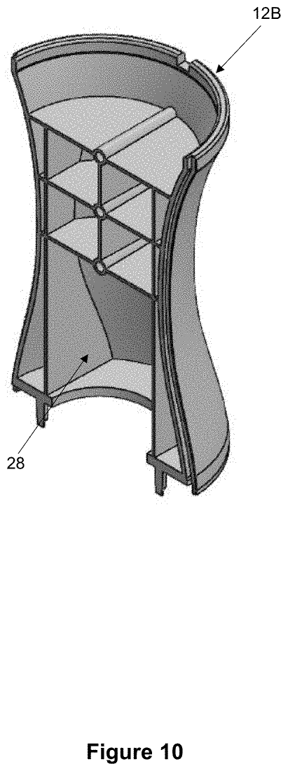

With reference to FIGS. 7-10 there is shown a first part 12A and a second part 12B of the body portion 12 (as seen in FIG. 1). The first part 12A and the second part 12B define a space 28 to accommodate the cover member 16.

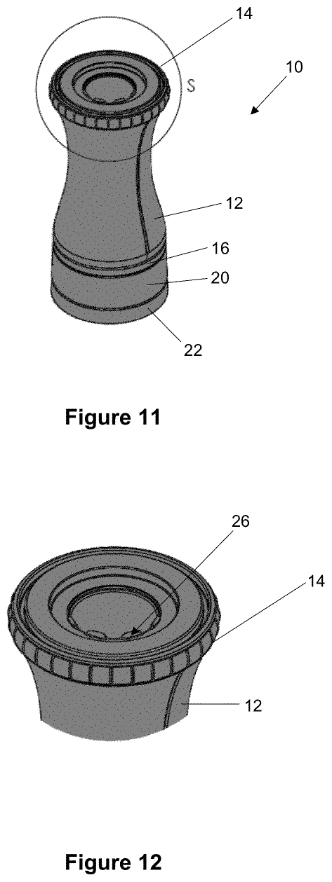

With reference to FIGS. 11 and 12 there is shown the coffee capsule recycling assembly 10 with the lid 24 removed. The arcuate blade member 26 of the cutter portion 14 can be seen in more detail.

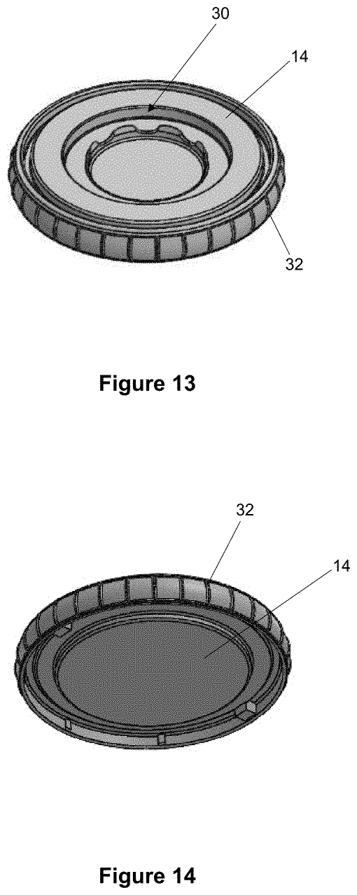

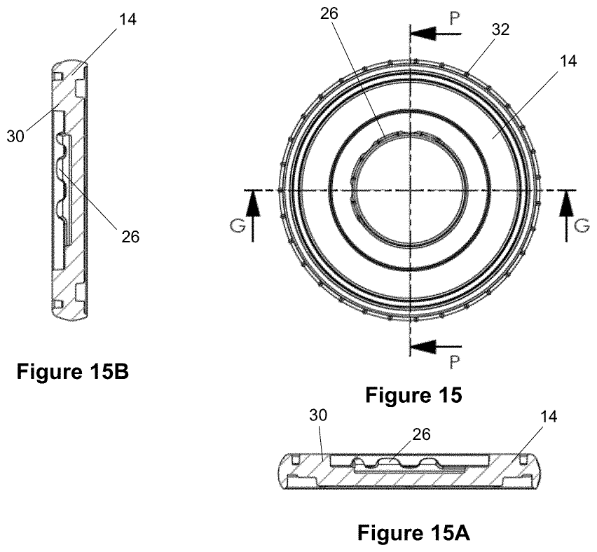

With reference to FIGS. 13-15B, there is shown the cutter portion 14 in more detail. The cutter portion 14 has a shoulder portion 30 to assist with locating a coffee capsule (not shown) with a lid of the coffee capsule towards the blade member 26. In use, the shoulder portion 30 enables the coffee capsule to be located and rotated such that the blade member 26 cuts an opening into the lid of the coffee capsule.

The cutter portion 14 includes a ribbed exterior 32 to enable a user to securely hold onto the cutter portion 14.

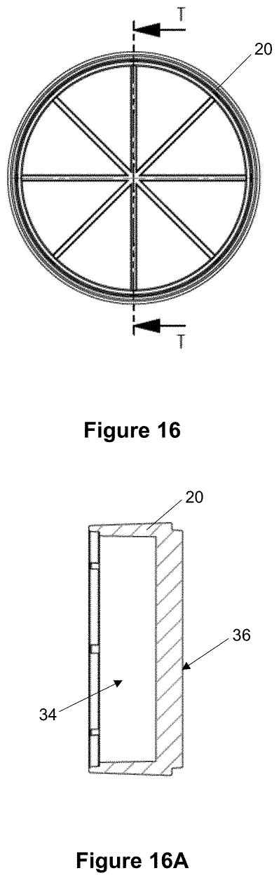

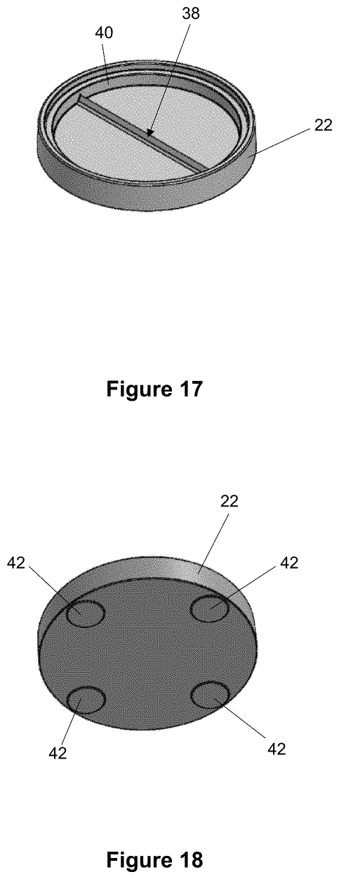

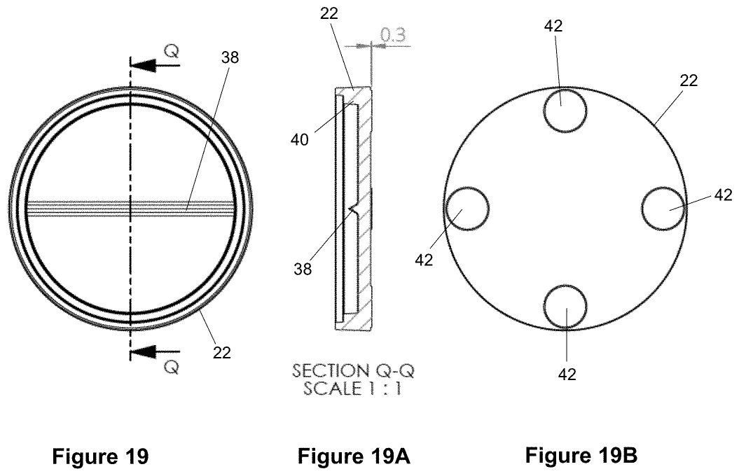

With reference to FIGS. 16 and 16A, there is shown the first crush portion 20. The first crush portion 20 defines an opening 34 to receive a part of the spatula member 18. The first crush portion 20 also has a planar portion 36 which in use can be used to push a coffee capsule (not shown) against the second crush portion 22 (best seen in FIGS. 17-19B).

With reference to FIGS. 17-19B there is shown the second crush portion 22. The second crush portion 22 includes a score member 38. The score member 38 is wedge shaped. The second crush portion 22 also includes a shoulder portion 40 to assist with locating a coffee capsule (not shown) in use. The second crush portion 22 also includes feet 42 to support the second crush portion 22 on a surface (not shown) and to inhibit the second crush portion 22 from sliding on the surface.

In use, a used and emptied aluminium coffee capsule (not shown) is located between the first crush portion 20 (see FIGS. 16 and 16A) and the second crush portion 22. The first crush portion 20 is pressed towards the second crush portion 22, compacting the coffee capsule. The score member 38 creates an indentation in the coffee capsule as it is being compacted. The indentation enables the compacted coffee capsule to be substantially folded. In the folded condition, the compacted coffee capsule can be inserted into a mouth of an aluminium drink can. In this manner, one or more aluminium coffee capsules can be effectively recycled in a recycling plant that can recycle aluminium drink cans.

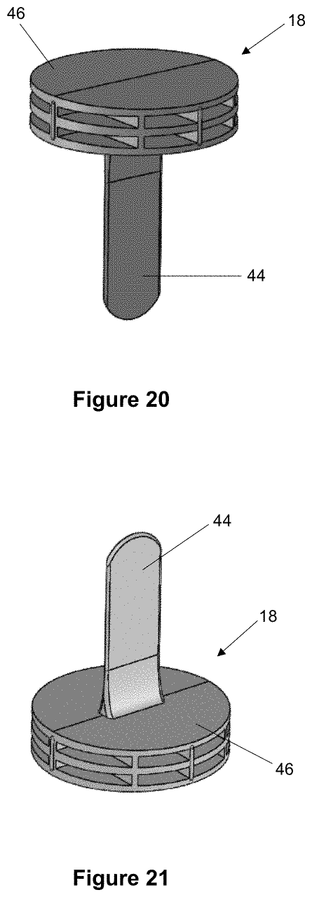

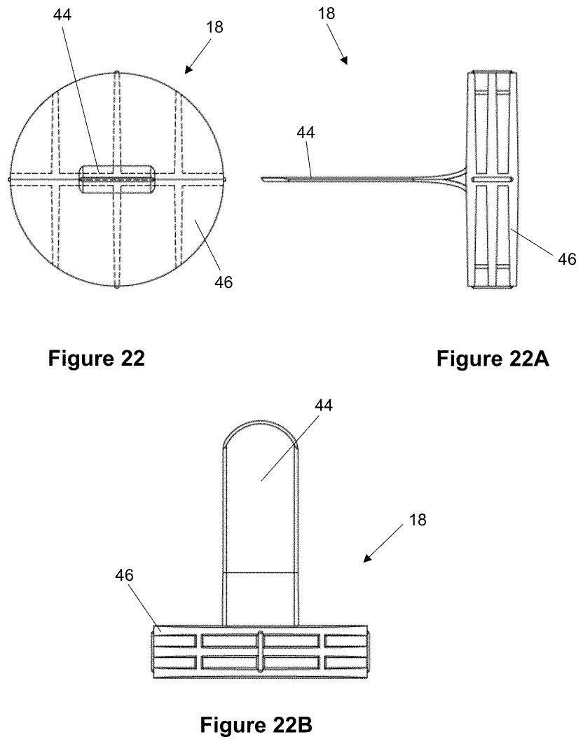

With reference to FIGS. 20-22B there is shown the spatula member 18 in more detail. The spatula member 18 has a planar portion 44 and a base portion 46. In use, when the lid of a coffee capsule (not shown) has been cut open, a user can manipulate the spatula member 18 by holding the base portion 46. The planar portion 44 is used to scoop out used coffee grounds out of the coffee capsule.

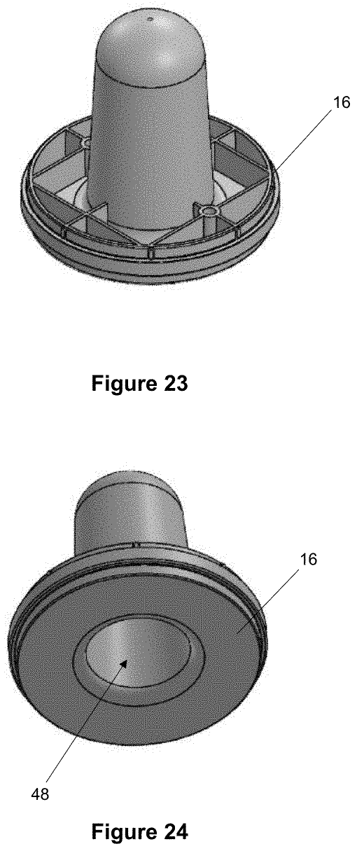

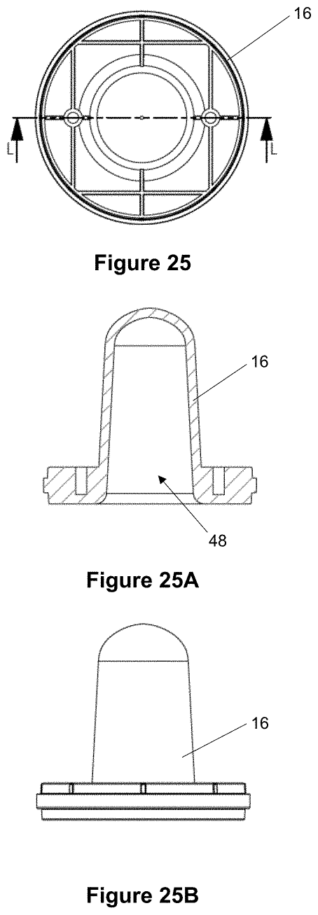

With reference to FIGS. 23-25B there is shown the cover portion 16 in more detail. The cover portion 16 defines an opening 48. The opening 48 is adapted to accept the planar portion 44 of the spatula member 18 (not shown).

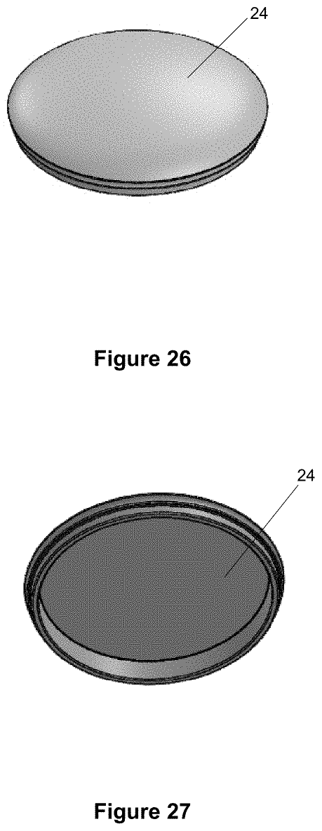

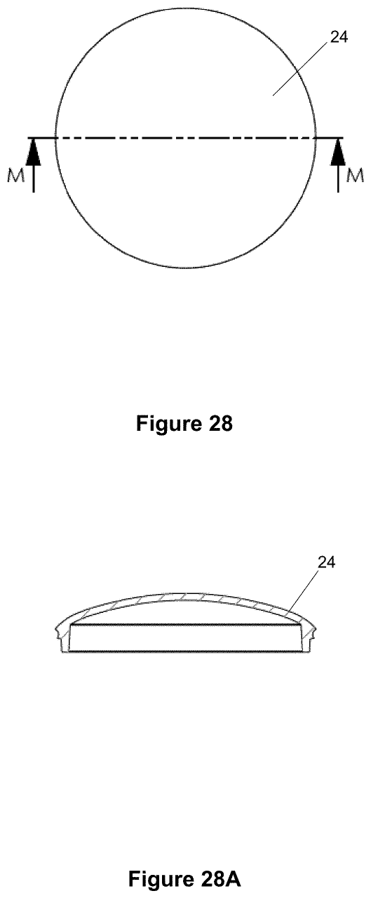

With reference to FIGS. 26-28A, there is shown the lid 24 in more detail. when the coffee capsule recycling assembly 10 (best seen in FIG. 1) is in a storage condition, the lid 24 is attached to the cutter portion 14 and covers the blade member 26.

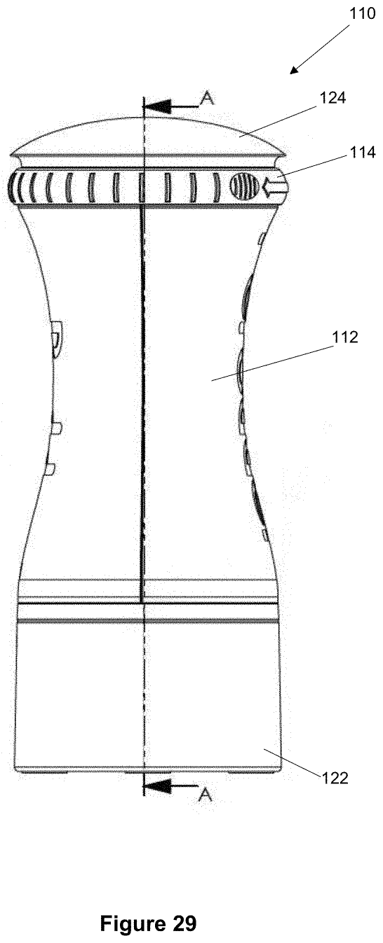

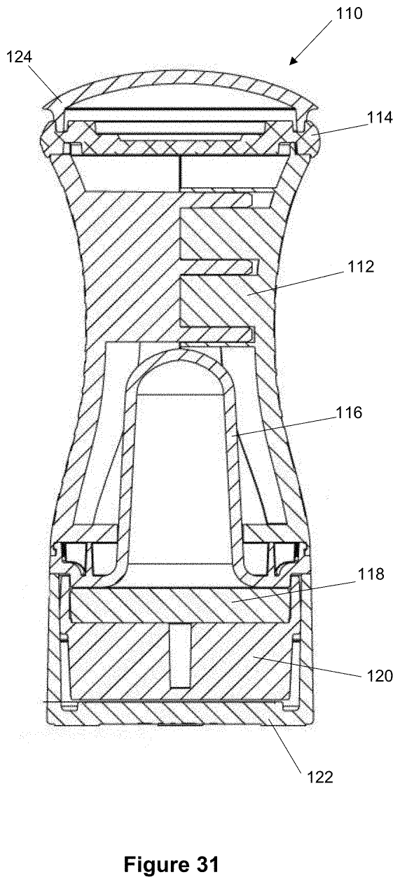

With reference to FIGS. 29 to 31 there is shown a beverage capsule recycling assembly in the form of a coffee capsule recycling assembly 110 according to another embodiment of the present invention, the coffee capsule recycling assembly 110 is similar to the coffee capsule recycling assembly 10 of FIG. 1 and will use similar numbering with a prefix of 1.

The coffee capsule recycling assembly 110 has a body portion 112. A cutter portion 114 is attachable to the body portion 112.

The coffee capsule recycling assembly 110 has a cover portion 116 which partially fits into the body portion 112. The coffee capsule recycling assembly 110 includes a spatula member 118 which is insertable into the cover portion 116. A first crush portion 120 is attachable to the cover portion 116. The spatula member 118 is containable within a space defined by the cover portion 116 and the first crush portion 120 when the cover member 116 and the first crush portion 120 are attached to each other.

The coffee capsule recycling assembly 110 includes a second crush portion 122. The second crush portion 122 is attachable to the first crush portion 120.

The coffee capsule recycling assembly 110 includes a lid 124 to cover the cutter portion 114.

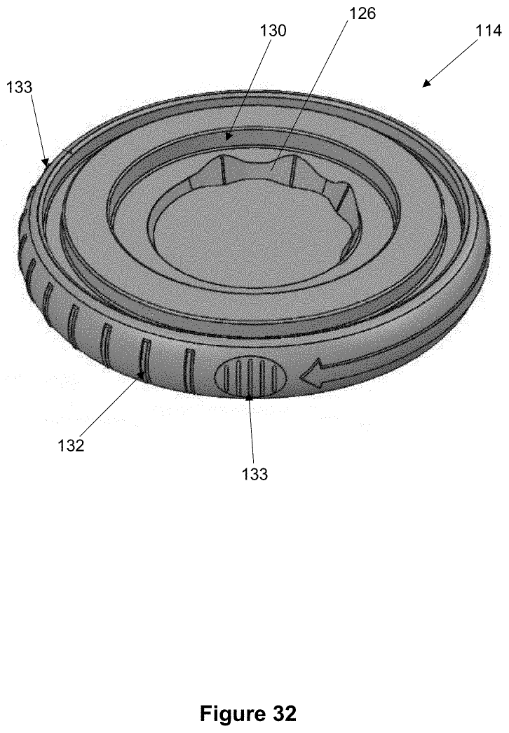

With reference to FIG. 32, there is shown the cutter portion 114 in more detail. The cutter portion 114 has a blade member 126 attached to the cutter section 114. The blade member 126 is adapted to cut a lid of a coffee capsule (not shown) so that the coffee grounds in the coffee capsule are accessible. The cutter portion 114 has a shoulder portion 130 to assist with locating a coffee capsule (not shown) with a lid of the coffee capsule towards the blade member 126. In use, the shoulder portion 130 enables the coffee capsule to be located and rotated such that the blade member 126 cuts an opening into the lid of the coffee capsule.

The cutter portion 114 includes a ribbed exterior 132 to enable a user to securely hold onto the cutter portion 114. The cutter portion 114 also includes thumb guides 133. The thumb guides 133 provide a reference so that a user can partially turn a coffee capsule (not shown) so that a lid of the coffee capsule is cut but remains attached to the coffee capsule.

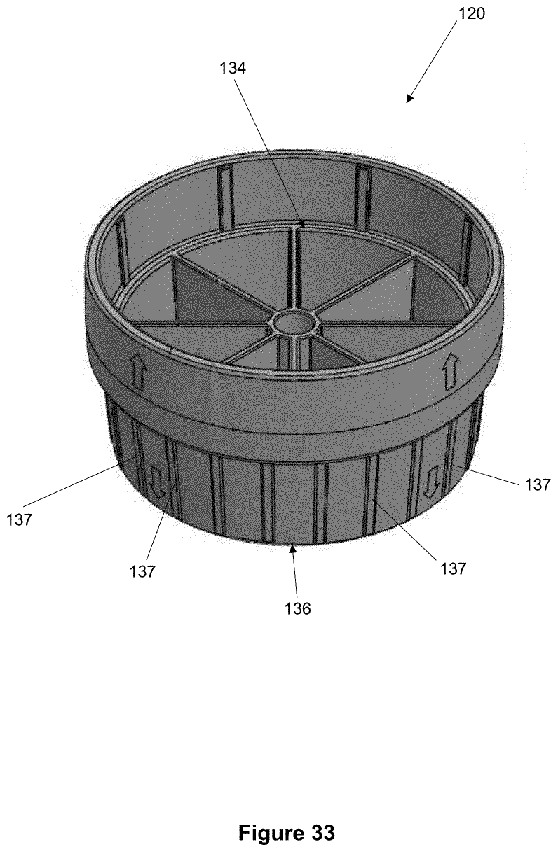

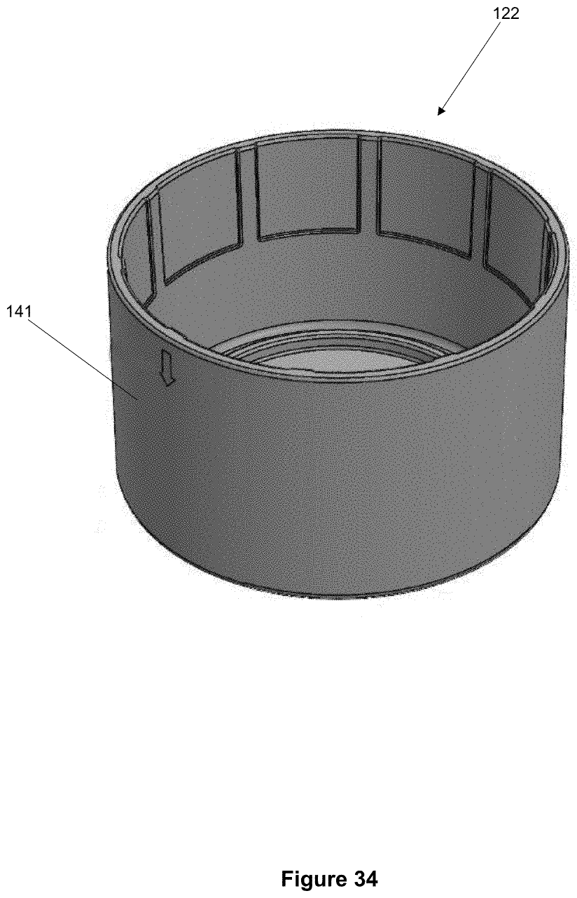

With reference to FIG. 33, there is shown the first crush portion 120 in more detail. The first crush portion 120 defines an opening 134 to receive a part of the spatula member 118. The first crush portion 120 also has a planar portion 136 which in use can be used to push a coffee capsule (not shown) against the second crush portion 122 (best seen in FIG. 34). The first crush member 120 also includes a plurality of guides 137. The guides 137 are adapted to guide the first crush portion 120 as it moves relative to the second crush portion 122. The guides 137 enable air to escape between the first crush portion 120 and the second crush portion 122 as they move relative to each other.

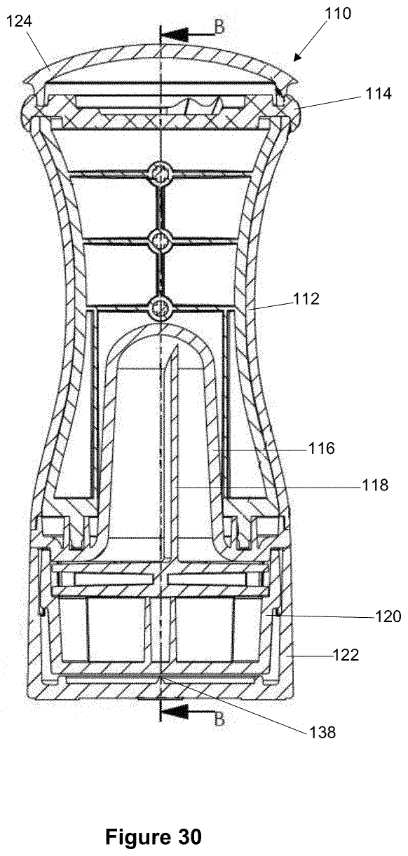

With reference to FIG. 34, there is shown the second crush portion 122. The second crush portion 122 includes a score member 138 (best seen in FIG. 30). The score member 138 is wedge shaped. The second crush portion 122 also includes a collar portion 141 to assist with aligning the first crush portion 120 and the second crush portion 122 as they move relative to each other.

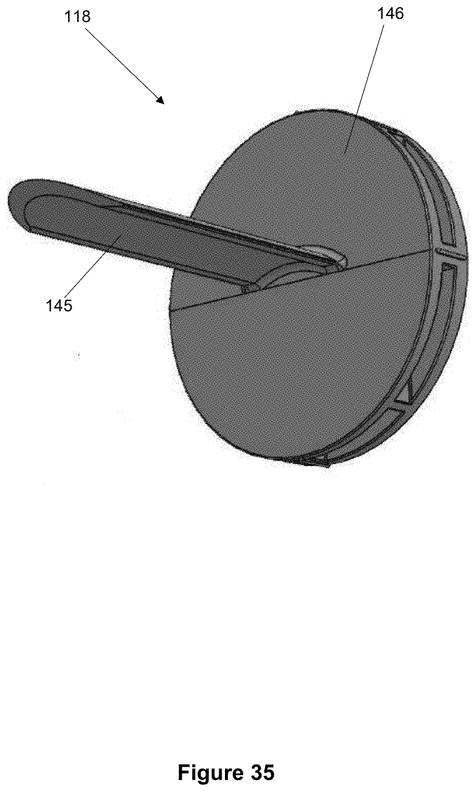

With reference to FIG. 35 there is shown the spatula member 118 in more detail. The spatula member 118 has a curved portion 145 and a base portion 146. In use, when the lid of a coffee capsule (not shown) has been cut open, a user can manipulate the spatula member 118 by holding the base portion 146. The curved portion 145 is used to scoop out used coffee grounds out of the coffee capsule.

### Advantages

An advantage of the preferred embodiment of the beverage capsule recycling assembly includes the ability to remove organic matter from a capsule. Another advantage of the preferred embodiment of the beverage capsule recycling assembly includes the ability to compact an empty beverage capsule. A further advantage of the preferred embodiment of the beverage capsule recycling assembly includes enabling the beverage capsule to be folded. A further advantage of the preferred embodiment of the beverage capsule recycling assembly includes that the compacted beverage capsule can be inserted into an aluminium can for recycling. Another advantage of the preferred embodiment of the beverage capsule recycling assembly includes the ability to utilise the contents of the beverage capsules for compost. A further advantage of the preferred embodiment of the beverage capsule recycling assembly includes the ability to use domestic recycling infrastructure, reducing the required carbon footprint to recycle a beverage capsule.

### Variations

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A beverage capsule recycling assembly for preparing a beverage capsule for recycling, the beverage capsule recycling assembly having
a body portion
a cutter portion integral with or attachable to the body portion, the cutter portion having a blade member to cut a lid of the beverage capsule;
a first crush portion associated with the body portion; and
a second crush portion,
wherein when the first crush portion and the second crush portion are in a use condition, the beverage capsule can be located between the first crush portion and the second crush portion, and the first crush portion can be moved towards the second crush portion to compact the beverage capsule.

2. A beverage capsule recycling assembly as claimed in claim 1, wherein one of the first crush portion or the second crush portion includes a score member, and wherein when the beverage capsule is being compacted between the first crush portion and the second crush portion, the score member scores an indentation into the beverage capsule.

3. A beverage capsule recycling assembly as claimed in claim 2, wherein the second crush portion includes the score member.

4. A beverage capsule recycling assembly as claimed in claim 2, wherein the score member is in the form of a ridge.

5. A beverage capsule recycling assembly as claimed in claim 1, wherein one of the first crush portion or second crush portion includes a collar portion, the collar portion being adapted to align the first crush portion and the second crush portion.

6. A beverage capsule recycling assembly as claimed in claim 5, wherein the collar portion includes one or more guides, the one or more guides adapted to guide the first crush portion or second crush portion as it moves relative to the collar, and adapted to enable air to escape between the collar portion and the first crush portion or second crush portion as it moves relative to the collar.

7. A beverage capsule recycling assembly as claimed in claim 5, wherein the second crush portion includes the collar portion.

8. A beverage capsule recycling assembly as claimed in claim 1, wherein in a storage condition, the first crush portion is attached to the second crush portion.

9. A beverage capsule recycling assembly as claimed in claim 1, further including a spatula member removably locatable within at least a portion of the body member, and wherein the spatula member has a tongue portion which can be used to remove the contents of the beverage capsule when the lid has been cut open.

10. A beverage capsule recycling assembly as claimed in claim 1, further including a lid attachable to the cutter portion, wherein when the lid is attached to the cutter portion, the blade member is covered by the lid.

11. A beverage capsule recycling assembly as claimed in claim 1, wherein the body portion is substantially circular in cross section and has a first end and a second end, and wherein a middle section of the body portion has a smaller width than the first end and the second end.

12. A beverage capsule recycling assembly as claimed in claim 1, wherein the parts of the beverage capsule recycling assembly are predominantly made of a plastic material.

13. A beverage capsule recycling assembly for preparing a beverage capsule for recycling, the beverage capsule recycling assembly having
a body portion;
a cutter portion integral with or attachable to the body portion, the cutter portion having a blade member to cut a lid of the beverage capsule;
a first crush portion associated with the body portion;
a second crush portion; and
a score member associated with one of the first crush portion or the second crush portion,
wherein when the first crush portion and the second crush portion are in a use condition, the beverage capsule can be located between the first crush portion and the second crush portion, and the first crush portion can be moved towards the second crush portion to compact the beverage capsule, and wherein when the beverage capsule is being compacted between the first crush portion and the second crush portion, the score member scores an indentation into the beverage capsule.

14. A beverage capsule recycling assembly for preparing a beverage capsule for recycling, the beverage capsule recycling assembly having
a body portion;
a cutter portion integral with or attachable to the body portion, the cutter portion having a blade member to cut a lid of the beverage capsule;
a first crush portion associated with the body portion; and
a score member,
wherein when the first crush portion is in a use condition, the beverage capsule can be compacted by the first crush portion and wherein the score member scores an indentation into the beverage capsule.

15. A beverage capsule recycling assembly as claimed in claim 1, wherein the beverage capsule is a coffee capsule predominantly made of aluminium.

16. A method of preparing a beverage capsule for recycling, including the steps of:
providing a beverage capsule recycling assembly having a body portion, a cutter portion integral with or attachable to the body portion, the cutter portion having a blade member to cut a lid of the beverage capsule; a first crush portion associated with the body portion; and a second crush portion, wherein when the first crush portion and the second crush portion are in a use condition, the beverage capsule can be located between the first crush portion and the second crush portion, and the first crush portion can be moved towards the second crush portion to compact the beverage capsule;
locating the beverage capsule on the cutter portion such that the blade member cuts into a lid of the beverage capsule;
rotating the beverage capsule relative to the cutter portion such that the blade member cuts an opening into the lid of the beverage;
removing the contents of the beverage capsule;
locating the beverage capsule between the first crush portion and the second crush portion; and
moving the first crush portion towards the second crush portion to compact the beverage capsule.

17. A method as claimed in claim 16, wherein the step of moving the first crush portion towards the second crush portion to compact the beverage capsule includes indenting the beverage capsule with a score member.

18. A method as claimed in claim 17, further including the step of folding the compacted beverage capsule along the indentation.

19. A method as claimed in claim 18, further including the step of inserting the compacted and folded beverage capsule into an aluminium can.

20. A method as claimed in claim 16, wherein the step of removing the contents of the beverage capsule includes using a spatula member to scoop the contents out of the beverage capsule.
